(19) United States
(12) Patent Application Publication
(10) Pub. No.: US 2009/0193415 A1
(43) Pub. Date: Jul. 30, 2009

(54) DEVICE AND METHOD FOR EXECUTING A POSITIONAL CONDITION TASK BASED ON A DEVICE POSITION AND POSITIONAL DERIVATIVES

(76) Inventors: Chandrasekhar Narayanaswami, Wilton, CT (US); Mandayam Thondar Raghunath, Bangalore (IN); Marcel C. Rosu, Ossining, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/023,009

(22) Filed: Jan. 30, 2008

(51) Int. Cl. G06F 9/46

(52) U.S. Cl. 718/100

(57) ABSTRACT

A device that executes and a method for executing a positional condition executable task which includes a position determining unit that determines a position of the device, a position derivative generation unit that generates one of a distance-based and a time-based derivative from the position of the device, an input interface that receives a user-defined positional trigger condition, a memory unit that stores a positional condition executable task, and a processor that executes the positional condition executable task based on one of the determined position of the device and the generated derivative from the position of the device with respect to the user-defined positional trigger condition.

### BACKGROUND OF THE INVENTION

1. Field of the Invention

The present invention generally relates to a device and method for executing a positional condition executable task based on a determined position of a device or a generated position derivative of the device with respect to a positional trigger condition.

2. Description of the Related Art

Tasks and processes may be scheduled to be automatically triggered and run at a future time on several computing platforms. This feature has been available for several decades on computing platforms. For instance, it is possible to set up a backup task so that it is triggered every 6 hours, or run a “cron job” on a UNIX based system every night at 12:30 a.m. to rotate log files, or to synchronize files with a server every Thursday at 4:00 a.m. This very useful utility relieves the user from having to be physically near the computer to manually launch the task or process. For example, early in the day, a user may schedule several tasks to be executed at night on a computer at work and leave for home.

In the past, most computers were mostly kept in a fixed location for a long period of time. However, since the early nineties, several computer types such as laptops and personal digital assistants (PDAs) have become mobile. In addition, vehicles have begun to incorporate several computers for improving the driver and passenger experience and safety. The mobility of computers coupled with the wide array of tasks they perform makes additional task scheduling modalities necessary. In specific, on mobile systems it is useful to trigger tasks based on location, velocity, acceleration, proximity to other devices, distance to other devices, rate of change of distance to other devices, and so on, in addition to time. The term ‘generalized’ position will be used herein for any of these coordinates and coordinate derivatives.

Prior art in the area of location based services addresses a related but different problem. With location based services, services that are relevant to a particular location become available to a mobile device when the device is in the relevant location. Prior to the present invention, there has been no system or method which effectively addresses the problem of executing a local task (i.e., a task that will run on the mobile device) that may or may not be triggered based on the ‘generalized’ location of the device.

WO 2004 083888 A2 PCT/US2004/008559 describes turning devices on and off in certain zones. In addition, the device may send signals to other devices. The zones may include theaters, airports, hospitals, gas stations, etc.

There has been no recognition in the prior art of when a device leaves a certain zone it may perform a certain task, such as turning the cell phone on once the user leaves the theater, wherein the focus is on controlling the device, i.e., controlling the execution of individual applications/executables on the portable device, not merely changing the on/off status of the entire device.

U.S. Pat. No. 6,177,905 allows users to create reminders that may be delivered when the user is at a particular location. The reminders may be for tasks such as buying milk, picking up photos, etc. A system to create these reminders and a method to deliver these reminders is described. The present location is checked with a table to see if any alert is to be delivered. The reminder may be delivered on the screen or as an audio message. This process is done repeatedly on the mobile device, making the process both inefficient and unreliable due to the required and excessive processing.

There has been no recognition in the prior art of controlling the execution of individual applications/executables on the portable device based on position and derivatives of position, not about a single continuously running task on the mobile device dedicated to the delivery of reminders at different locations.

U.S. Patent Application Pub. No. US 2001/0003835 A1 describes how a computer might react to changes in environmental conditions, such as software configurations, network configurations, and physical location, etc. The application describes detection circuitry to detect environmental factors and processing circuitry to execute one or more software informants for receiving information on environmental factors from the detection circuitry and executes one or more applications in communication with said software information, the operation of the application programs being responsive to the information. Examples provided include changing default printers when the computer's physical location is changed say between work and home.

There has been no recognition in the prior art of controlling the execution of individual applications/executables on the portable device based on position and derivatives of position and not about the computer responding to changes in environment such as whether it is docked or undocked.

U.S. Pat. No. 6,615,276 B1 describes that the user may configure different settings for networking, printers, etc., and then choose one of them when the user's location changes. There is provision to automatically try different configurations if one configuration fails.

There has been no recognition in the prior art of controlling the execution of individual applications/executables on the portable device based on position and derivatives of position and not about creating profiles for a fixed set of locations that may be detected from information about the network connection.

U.S. Pat. No. 5,470,233 describes a GPS based tracking system that helps track a pedestrian navigate through a city. The city/location name is then output to a voice synthesizer which may guide a blind person to navigate a city by reading out landmarks in the vicinity of the user. For every location, the closest landmarks are retrieved. In this sense the computer is executing a task at every location. However, it is the same task that is constantly running. No individual tasks are triggered based on location, the one continuously running task retrieves geographic landmarks and delivers messages to the user.

U.S. Pat. No. 5,497,149 describes a human Lo-Jack® system. If a person is outside certain boundaries or inside certain boundaries, then a message is sent. In this case the same task is running at all locations and essentially looking for violations. No tasks specific to a particular location are executed.

### SUMMARY OF THE INVENTION

In view of the foregoing and other exemplary problems, drawbacks, and disadvantages of the conventional methods and structures, a purpose of the exemplary aspects of the present invention is to provide:

The lowest level of abstraction tags each of one or more tasks with a set of ‘generalized’ location bounding boxes or position conditions. The mobile device has a location sensing mechanism such as GPS (for outdoors) or some other mechanism such as WiFi-based positioning (for indoors). When the mobile device enters one of the bounding boxes associated with the task, the task gets triggered. In a simple case, the device may periodically poll its location and compare the current location coordinates against the set of bounding boxes associated with each of the pending tasks. If a containment relationship is found, then the task is retrieved and executed.

An exemplary aspect of the present invention includes a device that executes a positional condition executable task, includes a position determining unit that determines a position of the device, a position derivative generation unit that generates one of a distance-based and a time-based derivative from the position of the device, an input interface that receives a user-defined positional trigger condition, a memory unit that stores a positional condition executable task, and a processor that executes the positional condition executable task based on one of the determined position of the device and the generated derivative from the position of the device with respect to the user-defined positional trigger condition.

In another exemplary aspect of the present invention, the position determining unit includes a global positioning system receiver-processor.

In another exemplary aspect of the present invention, the one of the distance-based and time-based derivative includes one of a relative distance between two positions, a relative distance between two positions over a period of time, a velocity of the device, an acceleration of the device, and a rate of change of acceleration of the device.

Another exemplary aspect of the present invention, includes a mobile device detection unit operable with the position determining unit, the position derivative generation unit and the processor that determines one of a proximity and a distance from another mobile device.

In another exemplary aspect of the present invention, the mobile device detection unit further includes one of a wireless communication transceiver and a protocol that determines a location of the another mobile device from one of position information transmitted from the another mobile device to the device and a communication parameter detected from a transmitter of the another mobile device, wherein the communication parameter includes one of a signal strength of the transmitter, a transmission power of the transmitter, a quality of service of the transmitter and an operation protocol of the transmitter.

In another exemplary aspect of the present invention, the processor unit executes the positional condition executable task based on one of a determined position of the another mobile device and a generated derivative from a position of the another mobile device with respect to the user-defined positional trigger condition.

In another exemplary aspect of the present invention, the user-defined positional trigger condition includes one of a specific position of the device, a relative distance from the specific position of the device, a velocity of the device generated by the position derivative generation unit, an acceleration of the device generated by the position derivative generation unit, a specific range of one of the velocity or the acceleration of the device, a boundary region defined by at least three boundaries, a proximity of the device to a cartographic feature, a proximity of the device to another wireless device, and a device location history.

In another exemplary aspect of the present invention, the boundary condition includes one of a predefined geographic boundary region, a predefined geometric shape of a boundary region, and a contour including one of a predefined geographic boarder and a user-defined boundary.

In another exemplary aspect of the present invention, the user-defined positional trigger condition further includes one of a time and a date.

In another exemplary aspect of the present invention, the memory unit stores and recalls device position data over a period of time.

In another exemplary aspect of the present invention, the positional condition executable task includes one of an executable reminder task, an automatic data download task, an operating system housekeeping task, an active task termination function, an automatic communication task, and automatic control of normally user-controlled subsystem of the device.

In another exemplary aspect of the present invention, the positional condition executable task further includes user-definable options to control the execution of the positional condition executable task to one of run only once and auto-terminate the task, run at a defined periodic frequency, run until user-terminated, run only after a specified period of time, and run only up until a specified period of time.

In another exemplary aspect of the present invention, the processor unit executes the positional condition execution task stored in one of the memory unit, and a storage memory of another remote device.

In another exemplary aspect of the present invention, the processor unit executes the positional condition executable task with respect to a plurality of the user-defined positional trigger conditions.

In another exemplary aspect of the present invention, a device that executes a positional condition executable task, includes a position determining unit that determines a position of the device, a position derivative generation unit that generates one of a distance-based and a time-based derivative from the position of the device, a memory unit that stores a positional condition executable task including an embedded positional trigger condition, and a processor unit that executes the stored positional condition executable task based on one of the determined position of the device and the generated derivative from the position of the device with respect to the embedded positional trigger condition.

In another exemplary aspect of the present invention, one of the distance-based and time-based derivative includes one of a relative distance between two positions, a relative distance between two positions over a period of time, a velocity of the device, an acceleration of the device, and a rate of change of acceleration of the device.

In another exemplary aspect of the present invention, the embedded positional trigger condition includes one of a specific position of the device, a relative distance of the device from the specific position, a velocity of the device generated by the position derivative generation unit, an acceleration of the device generated by the position derivative generation unit, a boundary region defined by at least three boundaries, a proximity of the device to a cartographic feature, a proximity of the device to another wireless device, and a device location history.

In another exemplary aspect of the present invention, the positional condition executable task includes one of an executable reminder task, an automatic data download task, an operating system housekeeping task, an active task termination function, an automatic communication function, and automatic control of normally user-controlled subsystem of the device.

In another exemplary aspect of the present invention, a method of triggering a positional condition executable task on a digital processing apparatus based on a positional trigger condition, the method includes determining a position of a device, generating a position derivative of the device from the determined position, receiving a positional trigger condition to execute a positional condition executable task stored in a storage memory, determining if the positional trigger condition is satisfied based on one of the determined position of the device and the generated derivative from the position of the device, and executing the positional condition executable task based on the positional trigger condition being satisfied.

In still another aspect, a programmable storage medium tangibly embodying a program of machine-readable instructions executable by a digital processing apparatus to perform operations supporting executing a positional condition program, the operations includes creating an executable program, creating a position specific executable condition that allows the program to execute on the digital processing apparatus when the position specific executable condition is satisfied, embedding the position specific executable condition in the program, transferring the program including the embedded position specific executable condition to a digital processing apparatus, and executing the program including the embedded position specific executable condition when the position specific executable condition is determined to be satisfied by the digital processing apparatus.

With its unique and novel features, the present invention provides a device and method for executing a positional condition executable task based a determined position of a device or a generated position derivative of the device with respect to said user-defined positional trigger condition.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1A illustrates a position in a coordinate space;

FIG. 1B illustrates an area defined by a position in a coordinate space having a fixed distance around the position;

FIG. 1C illustrates a bounded area defined by four adjoining boundary lines in a coordinate space;

FIG. 1D illustrates a boundary line defined by the line between two points in a coordinate space;

FIG. 1E illustrates an area defined by a cartographic feature, for example, by the coordinates of highway;

FIG. 2 illustrates a schematic of a first exemplary embodiment of the present invention including a positional executable task and a user-defined positional trigger condition for execution on a portable device;

FIG. 3 illustrates a first exemplary embodiment of the present invention which may be used for executing a positional condition executable task;

FIG. 4 describes an interface to specify execution of tasks that will be triggered by location;

FIG. 5 illustrates a schematic of a second exemplary embodiment of the present invention including a positional executable task and an embedded positional trigger condition for execution on a portable device;

FIG. 6 illustrates a second exemplary embodiment of the present invention which may be used for executing a positional condition executable task;

FIG. 7 describes a flowchart according to the first exemplary embodiment of the present invention; and

FIG. 8 describes a flowchart according to the second exemplary embodiment of the present invention.

### DETAILED DESCRIPTION OF EXEMPLARY EMBODIMENTS OF THE INVENTION

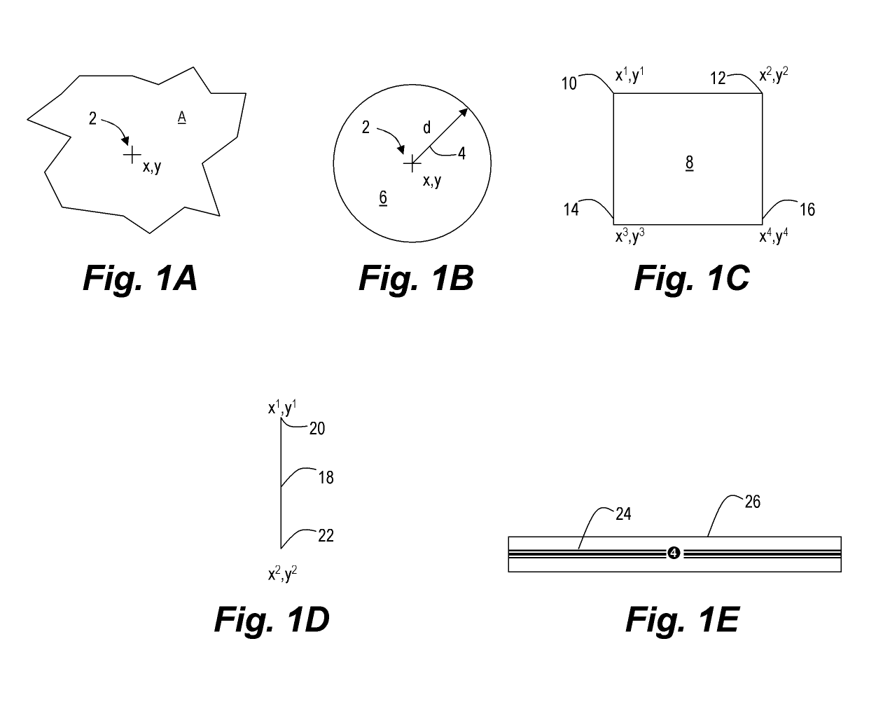

Referring now to the drawings, and more particularly to FIGS. 1A-8, there are shown exemplary embodiments of the device and method of the present invention.

The core idea of the invention is a new abstraction of the “generalized where” instead of “at” command in UNIX®. The “at” command in UNIX® allows users to specify the execution of a task at a particular time.

The present invention is exemplarily embodied as a computing system that is augmented with means to determine position and also derivatives of position such as velocity, acceleration, and rate of change of acceleration, the presence of other devices (mobile or stationary), rates of change of these distances, etc. The task may be anything that may be executed locally on the device or on another device with which a device may communicate.

Referring now to FIGS. 1A-1E, the lowest level of abstraction a user may specify that a task be executed is when a device is at a particular latitude and longitude within the parameters of a global positioning system (GPS). This feature is referred to as a user-defined positional trigger condition. As later discussed in the instant application, the trigger condition parameters may not be input by a user, but may be embedded within the actual executable task itself, independent of any user's input.

FIG. 1A shows a position 2 in a coordinate space A having the coordinates (x,y). The user may specify the geometric boundaries of a region and request that the task be executed when the device is within that region.

FIG. 1B shows a region may be an area defined by a fixed distance d, or a specified radius 4 around a location 2 having the coordinates (x,y) that defines a circle 6.

FIG. 1C shows a rectangular box 8, commonly referred to as a “bounding box,” defined by lines between coordinate points 10 (x¹,y¹), 12 (x²,y²), 14 (x³,y³) and 16 (x⁴,y⁴). More complicated regions may be specified by allowing the user to define an arbitrary ‘generalized’ polygon on a map.

FIG. 1D shows a boundary line 18 defined by two coordinate points 20 (x¹,y¹) and 22 (x²,y²). A single boundary line may be used to toggle a condition when a device crosses from one side of the line to the other. Additionally, predefined geographic boundaries or portions thereof may be used in this fashion to define a boundary line.

FIG. 1E shows a cartographic feature, for example, a highway “4” 24 having a predefined coordinate path where a boundary area 26 is located proximate to either the area or coordinate path made by the highway 24.

The low level abstraction described above is difficult to use since people do not generally think of locations in terms of bounding boxes. However, as the level of abstraction of the location specification increases, it becomes possible to set up interesting task scenarios. For instance in mapping a higher level notion of “near Grand Central Station” to a set of bounding boxes, it may be possible for a user to set up a mobile reminder to pick up a special brand of coffee that is available at a specialty coffee store near the station. If the level of abstraction is further increased to “near any sporting goods store,” then it will become possible for a user to set up a mobile reminder that reminds the user to buy soccer shin guards.

Additionally, a combination of different parameters may increase the versatility of the present invention, for example, in a commercial marketing context, when the level of abstraction of “near any sporting goods store,” is combined with “in February,” which makes it possible for a sporting goods advertiser to set up a mobile reminder on a user's mobile device that reminds the user to buy soccer shin guards for the upcoming spring soccer season.

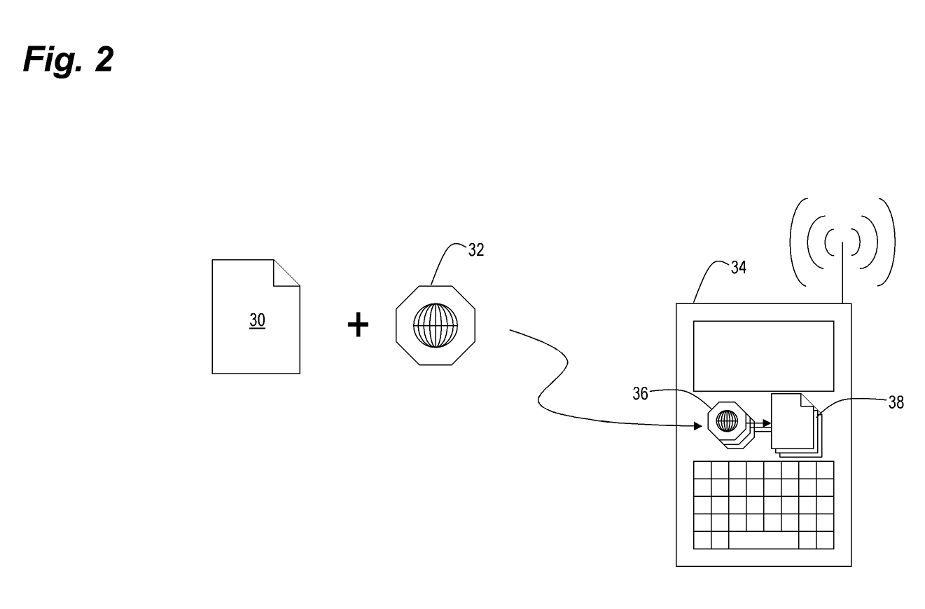

FIG. 2 shows a schematic of a first exemplary embodiment of the present invention in that a positional executable task 30 is associated with a user-defined positional trigger condition 32 for execution on a device 34. Device 34 may be either a portable device or a statically located device capable of determining its position and/or the position of other remote devices. A plurality of positional executable tasks 36 and their corresponding user-defined positional trigger conditions 38 may be loaded onto and/or stored within a storage memory of the portable device 34 which includes a position determination sensor and a processor to determine if any of the positional trigger conditions 38 are satisfied to trigger execution of their corresponding executable tasks 36. In one exemplary embodiment of the invention, the user selects an executable task and generates one or more positional trigger conditions to be associated with the executable task.

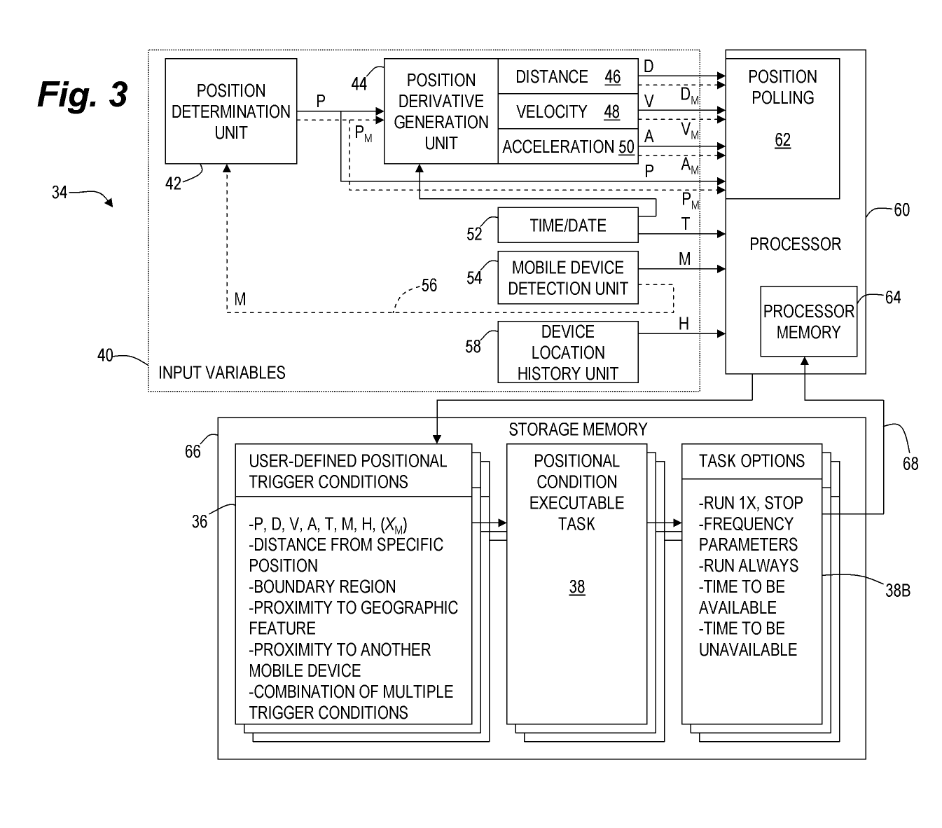

FIG. 3 shows the components of the portable device 34 of FIG. 2. An input variables 40 section as denoted by the dotted box outline identifies all inputs, both determined and generated, that are fed into processor 60 that are compared to a positional trigger condition 32.

The position determination unit 42 determines an actual position P of the device. This may be accomplished via a global positioning system (GPS) receiver/processor or any other device or system that can determine an actual location. The position P may be fed directly into the processor 60, or it may be fed into a time-based position derivative generation unit 44 that may generate a distance measurement D determined either between two position data or between periods of time. The position derivative generation unit 44 may also generate a velocity measurement V and an acceleration measurement A based on the position measurement P and an accurate clock timing signal. The position derivatives distance D, velocity V and acceleration A, may be input into the processor 60.

Additional input variables may include a time T input generated from a time/date unit 52. This feature allows position data P and position derivates D, V and A to be associated with a time or date. The output of the time/date unit 52 may be input into the position derivative generation unit 44 for calculating time/date based derivatives, and may be input directly into processor 60 for additional calculations.

A mobile device detection unit 54 can detect the presence of a remote mobile device and send a signal M representing the presence of a remote mobile device to processor 60 identifying the presence of a remote mobile device. Mobile device detection unit 54 may detect the presence of a remote mobile device by analyzing the relative strength of a wireless signal transmitted from the remote mobile device, or it may receive location coordinates of the remote mobile device. The mobile device detection unit 54 may transmit information of the detected presence of a remote mobile device directly to processor 60, or it may transmit a signal M representing the presence of a mobile device to the position determination unit 42 to process a position P_{M} of a remote mobile device to calculate positional derivatives D_{M}, V_{M} and A_{M} from the position derivative generation unit 44.

The device location history unit 58 typically found within a memory register of the mobile device 34 stores and recalls position history and position derivative history previously transmitted to processor 60.

Position inputs P, P_{M} and position derivative inputs D, D_{M}, V, V_{M}, A and A_{M} are input into processor 60 and specifically into a position polling unit 62. There are two choices for determining whether position conditions are satisfied. One may be to continuously check whether the position conditions are satisfied. This may place an inordinate amount of load on the main processor of the device. In order to reduce the load on the main processor, periodic polling of the inputs may be done. If the periodic time interval for polling is too large, some input events may be missed. For example, the device may pass through a boundary region between the polling intervals due to the fact that the polling interval was too large. If on the other hand the polling interval is too small, then the load on the processor will be larger but the system will miss fewer events. In order to handle a larger variety of situations, the interval at which the polling is done may depend on a positional derivative, e.g., the rate of change of position of the device, or the acceleration of the device. In addition, the characteristics of the generalized boundary region may be taken into consideration when determining the polling rate.

The processor 60 processes all of the input variables and compares them to user-defined positional trigger conditions 36 in a storage member 66. These user-defined positional trigger conditions 36 may be predefined as a single trigger condition or a combination of trigger conditions.

User-defined positional trigger conditions may include the position inputs P, P_{M} and position derivative inputs D, D_{M}, V, V_{M}, A and A_{M} as mentioned above, in addition to the geometric and cartographic features illustrated in FIGS. 1A-1E. For example, the predefined trigger conditions may include the distance from a specific position, a specified boundary region, the proximity to a geographic feature, the proximity and/or distance to another mobile device, or a combination of any of these and other trigger conditions.

Standard algorithms and data structures from computational geometry may be used to detect when conditions are met. Complex polygonal regions may be approximated to bounding boxes (the smallest rectangle that encloses the polygon such that the edges are horizontal and vertical) to speed up computation. For example, if the device is in a region that is outside the bounding box, then the device will not be inside the polygon. If the device is within the bounding box, then an actual test may be done to determine if the device is actually within the polygon.

The bounding boxes for all the conditions are preferably maintained in a sorted data structure such as quad trees or uniform grids or plane sweep trees. With this method, conditions may be checked incrementally and not all conditions have to be evaluated at each pass. For example, if it is known that two bounding boxes do not overlap, the system may conclude that if the device is within one of the bounding boxes then it cannot not be inside the other bounding box at the same time as well.

A group of conditions may be specified to trigger an executable task. One example would be when the user is at location X at time T, and at location Y at about time T+P. Another example would be when the user is at location X at about time T1 and at location Y at about time T2, where the precision of time measurement might be dependent on P, or on the distance between locations X and Y, or on the length of the time interval between T1 and T2. More complex examples could specify a sequence of positions and absolute times or relative times. Such conditions may be used to determine if the user is spending more than a certain amount of time in an area or circling around aimlessly along a particular road or path. Conditions may be combined using a composition language to specify a composite condition. An example of this would be when the user is in area X, defined by a boundary region, with a velocity of Y m/s and is accelerating at 7 m/s², trigger the executable task.

Combining location coordinates with speed information may also result in more complex scenarios for triggering task execution. A velocity vector of over 30 mph heading North from “near Grand Central Station” may mean that the user is on a train returning home. Since the user knows that such a train ride will last at least 45 minutes, the user may want to schedule a low priority operating system housekeeping task on his mobile device when the particular location and velocity conditions are met. Another example using directional vectors could detect if the user is retracing his path around a block by going East then North then West and then South at a particular speed.

Another example of a condition would be the acceleration experienced by the device. For example, if it is detected that the device is accelerating beyond 5 m/sec², then the user may want to specify that all files be saved to disk or be transferred wirelessly to a nearby device.

Further enhancing the idea of a position with respect to boundary regions may include detecting other wireless mobile devices, either within a boundary box in defining a specific location, or independent of its physical location. These conditions may be used to schedule tasks that must be executed only in the presence of or within a predetermined proximity to other wireless mobile devices, as determined by either the wireless signal strength generated or the coordinates that another wireless mobile device may transmit. The wireless mobile device may then determine either the general proximity of the other wireless mobile device or may determine an actual position or distance from the other wireless mobile device. Thereafter, as described above, the wireless mobile device may generate position derivatives from the position of the other wireless mobile device. These parameters may be used as position trigger conditions or may supplement other position trigger conditions.

In any of the above conditions, the mobile device does not need to reveal its location or velocity vector to any third party unless the user wants to do so. The location determination and the use of the location information are performed locally, thereby preserving the privacy of the user. This is generally not true of location-based services.

A trigger condition may combine a current position with location history to make it possible to trigger tasks that may run when some time-based and position-based criteria are met. For instance, if the mobile device discovers that it is currently located at an airport different from the airport it was located at when it last sensed its location, then the mobile device may infer that it had been turned off when the user traveled between the two airports. Upon “waking up” at the new airport, it may trigger a task to automatically notify the traveler's family that the flight has landed, or send an SMS to the rental car company that the customer is on his way.

When a condition to be evaluated is composed of several conditional clauses, the system will evaluate them in an efficient manner, evaluating the simpler conditional clauses first. For example, if the user is going at 20 kmph and the condition for task triggering is that the user must be traveling at 40 kmph and is inside a complex polygonal region, then there is no need to evaluate if the user is within the polygonal region. The complexity of evaluating a condition clause will be determined either by inspection or by measuring the time taken to evaluate a condition clause and using it as a data point for future estimations.

Several sets of conditions may be met at the same time thus triggering multiple tasks. In such cases, the tasks that need to be triggered will be triggered in a sequence that may respect other conditions such as relative priorities that may be specified by the user or determined by the processor.

A trigger condition may also stop an active task when certain location criteria are met. For instance, one may suspend a housekeeping task such as virus checking when the user reaches his home or office.

Just as timer tasks may be single occurring or repeating, positional condition tasks may also be specified at certain types of repeating tasks. These task options 38B may include running the task once and then stopping the task, running the task at a particular frequency or period interval. or running the task at all times until terminated. The task options may also include a period of time when the task is executable, or a period of time when the task is unavailable for execution. For example, a user may set up a task that downloads a particular audio file when they walk by a free wireless “hotspot” on their way to work every day so that they may listen to the audio file on the train ride home.

An additional modification to the first embodiment of the invention may be to off load the process of determining whether position conditions are satisfied to an outboard subsystem that may then interrupt the main processor 60. One example may be an enhanced GPS system that may accept conditions and check it in situ.

Finally, after the trigger condition or conditions 36 have been satisfied, the positional condition executable task 38 in addition to any task options 38B are then transferred from the storage memory 66 via bus 68 to processor memory 64 and then executed.

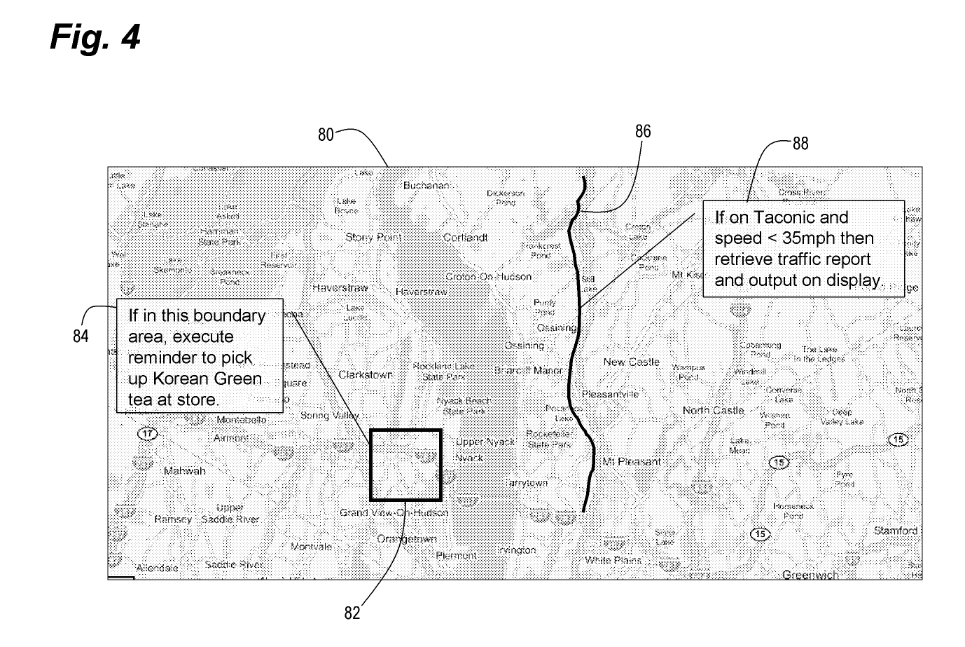

FIG. 4 shows one example of a user input being a screen used to define positional trigger conditions. A graphical map 80 is displayed wherein a boundary region 82, defined by a square-shaped polygon, is located over a certain user-defined geographic region. A positional condition executable task of a reminder is specified with a message 84 which reminds the user to pick up an item at a store when the device determines its position to be within the boundary region 82. Additionally, a cartographic feature of a highway 86 which is specified to be a first positional trigger condition is used in conjunction with a second positional trigger condition of a velocity input of 35 miles per hour such that a positional condition executable task is triggered when the location and speed inputs coincide with the user specific conditions to retrieve a traffic report and display the report on the device. Other user input interfaces may allow a user to specify a task and choose position trigger conditions by selecting an address, geographic feature or landmark without a graphical interface.

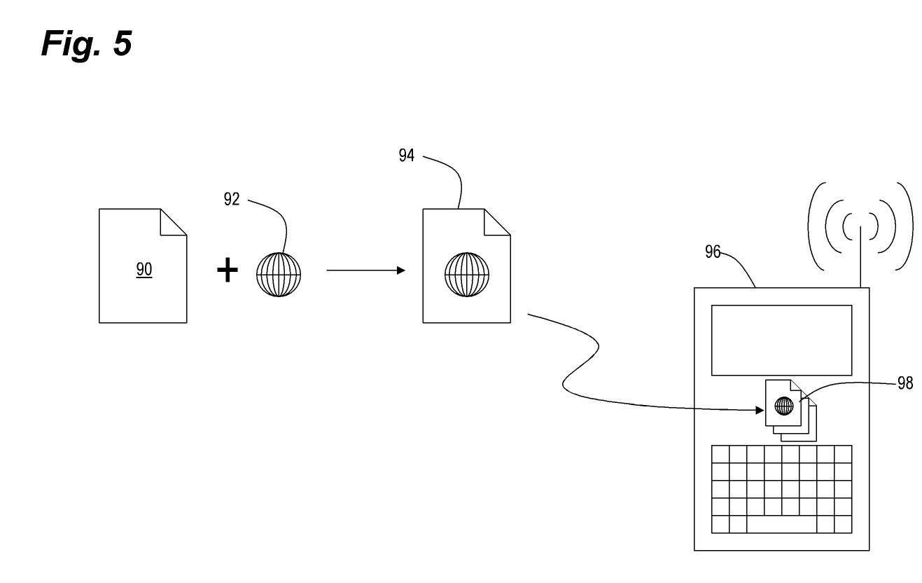

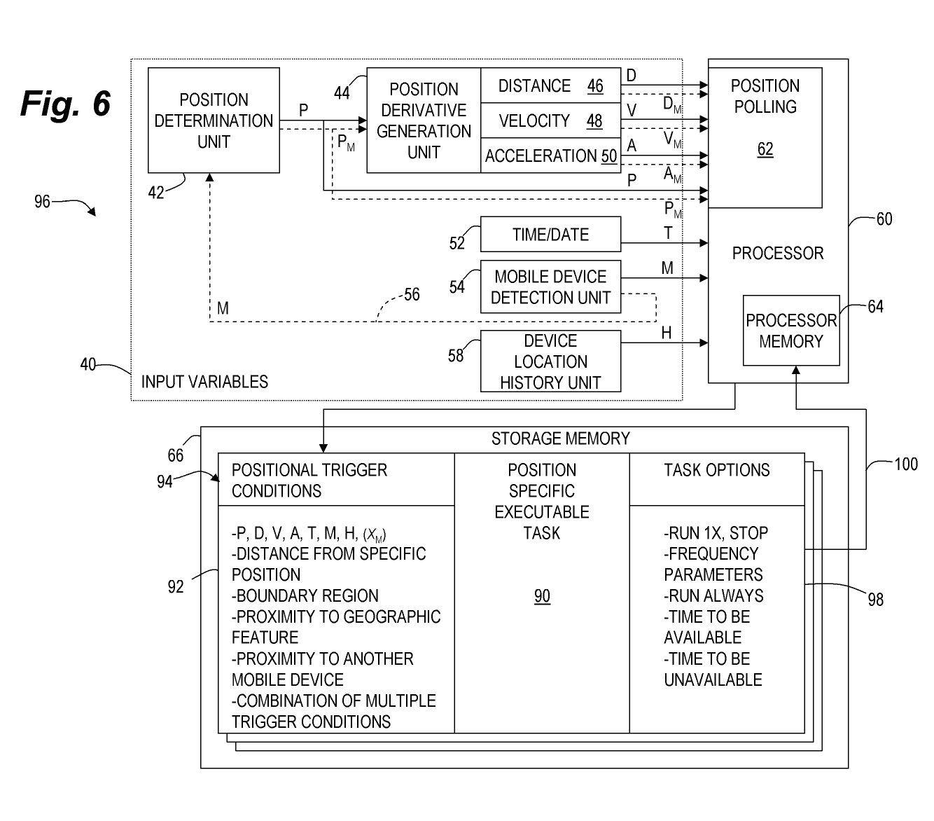

FIG. 5 shows a second embodiment of the present invention where a position specific executable task 90 is combined with a positional trigger condition or conditions 92 into an integrated position specific executable task of 94 having an embedded positional trigger condition or conditions. This integrated position specific executable task 94 or tasks 98 is loaded onto a device 96 without any user intervention. Hence, the integrated position specific executable task 94 and tasks 98 are triggered by the same input of the first embodiment of the invention as shown in FIG. 3, but there is no user input to define the positional trigger conditions 92, (see FIG. 6) and task options 100. The executable task containing the embedded trigger condition could change the embedded trigger condition when the task is run. For example, something that was being run when the acceleration was 3 m/s² could be changed to run at 4 m/s² based on program logic in the executable task.

FIG. 6 shows the user device 96 of FIG. 5 in a similar configuration as FIG. 2 with the exception of the integrated position specific executable task of 94 including the positional trigger conditions 92, the position specific executable task 90 and task options 98 stored and storage memory 66 and transferred to a processor memory 64 via bus 100.

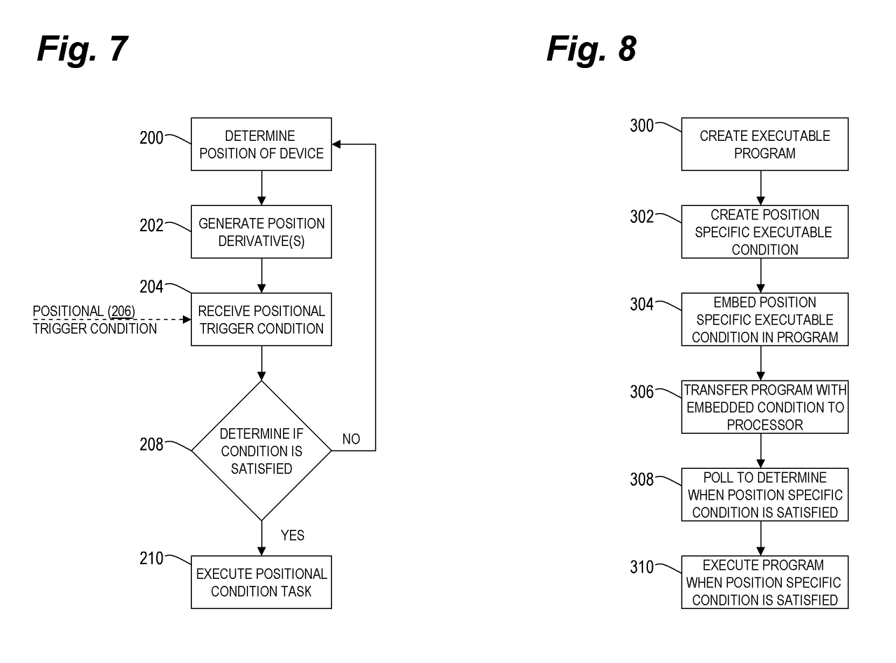

FIG. 7 demonstrates the operation of both the first and second embodiments of the present invention. First, the position determination unit 42 determines the position of the device (step 200). If necessary, position derivative generation unit 44 generates position derivatives (step 202). The unit receives (step 204) a positional trigger condition (206) from either a user in the first embodiment of the invention, or from within the integrated position specific executable task 94 in the second embodiment of the invention. The processor 60 then determines if the condition is satisfied (step 208) and then executes a positional condition task (step 210) when the condition has been determined to be satisfied. If it is determined that the condition is not satisfied, then the unit reverts back to determining the position of the device (step 200).

FIG. 8 demonstrates the operation of the second embodiment of the present invention in the creation of the integrated position specific executable task 94 of FIG. 6. First, an executable program is created (step 300). Next, a position specific executable condition is created (step 302) to correlate two the executable program as created in step 300. The position specific executable condition is embedded in the executable program (step 304), and subsequently transferred (step 306) to a processor that polls (step 308) at a either predetermined frequency or based on a determined location to determine when the position specific condition is satisfied, and executing the program (step 310) when the position specific condition is satisfied. For example, a portion of the executable code may be extracted from the program and run to determine if the complete executable program needs to be run. Once the position specific condition is satisfied, then the complete executable program is executed.

While the invention has been described in terms of one or more exemplary embodiments, those skilled in the art will recognize that the invention may be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention. Further, Applicant's intent is to encompass the equivalents of all claim elements, and no amendment to any claim the present application should be construed as a disclaimer of any interest in or right to an equivalent of any element or feature of the amended claim.

What is claimed is:

1. A device that executes a positional condition executable task, comprising:
a position determining unit that determines a position of said device;
a position derivative generation unit that generates one of a distance-based and a time-based derivative from said position of said device;
an input interface that receives a user-defined positional trigger condition;
a memory unit that stores a positional condition executable task; and
a processor that executes said positional condition executable task based on one of said determined position of said device and said generated derivative from said position of said device with respect to said user-defined positional trigger condition.

2. The device according to claim 1, wherein said position determining unit comprises a global positioning system receiver-processor.

3. The device according to claim 1, wherein said one of said distance-based and time-based derivative comprises one of:
a relative distance between two positions;
a relative distance between two positions over a period of time;
a velocity of said device;
an acceleration of said device; and
a rate of change of acceleration of said device.

4. The device according to claim 1, further comprising:
a mobile device detection unit operable with said position determining unit, said position derivative generation unit and said processor that determines one of a proximity and a distance from another mobile device.

5. The device according to claim 4, wherein said mobile device detection unit further comprises one of a wireless communication transceiver and a protocol that determines a location of said another mobile device from one of:
position information transmitted from said another mobile device to said device; and
a communication parameter detected from a transmitter of said another mobile device,
wherein said communication parameter comprises one of:
a signal strength of said transmitter;
a transmission power of said transmitter;
a quality of service of said transmitter; and
an operation protocol of said transmitter.

6. The device according to claim 4, wherein said processor unit executes said positional condition executable task based on one of a determined position of said another mobile device and a generated derivative from a position of said another mobile device with respect to said user-defined positional trigger condition.

7. The device according to claim 1, wherein said user-defined positional trigger condition comprises one of:
a specific position of said device;
a relative distance from said specific position of said device;
a velocity of said device generated by said position derivative generation unit;
an acceleration of said device generated by said position derivative generation unit;
a specific range of one of said velocity or said acceleration of said device;
a boundary region defined by at least three boundaries;
a proximity of said device to a cartographic feature;
a proximity of said device to another wireless device; and
a device location history.

8. The device according to claim 7, wherein said boundary condition comprises one of:
a predefined geographic boundary region;
a predefined geometric shape of a boundary region; and
a contour including one of a predefined geographic boarder and a user-defined boundary.

9. The device according to claim 7, wherein said user-defined positional trigger condition further comprises one of a time and a date.

10. The device according to claim 1, wherein said memory unit stores and recalls device position data over a period of time.

11. The device according to claim 1, wherein said positional condition executable task comprises one of:
an executable reminder task;
an automatic data download task;
an operating system housekeeping task;
an active task termination function;
an automatic communication task; and
automatic control of normally user-controlled subsystem of said device.

12. The device according to claim 1, wherein said positional condition executable task further comprises user-definable options to control the execution of the positional condition executable task to one of:
run only once and auto-terminate the task;
run at a defined periodic frequency;
run until user-terminated;
run only after a specified period of time; and
run only up until a specified period of time.

13. The device according to claim 1, wherein said processor unit executes said positional condition execution task stored in one of:
said memory unit; and
a storage memory of another remote device.

14. The device according to claim 1, wherein said processor unit executes said positional condition executable task with respect to a plurality of said user-defined positional trigger conditions.

15. A device that executes a positional condition executable task, comprising:
a position determining unit that determines a position of said device;
a position derivative generation unit that generates one of a distance-based and a time-based derivative from said position of said device;
a memory unit that stores a positional condition executable task including an embedded positional trigger condition; and
a processor unit that executes said stored positional condition executable task based on one of said determined position of said device and said generated derivative from said position of said device with respect to said embedded positional trigger condition.

16. The device according to claim 15, wherein one of said distance-based and time-based derivative comprises one of:
a relative distance between two positions;
a relative distance between two positions over a period of time;
a velocity of said device;
an acceleration of said device; and
a rate of change of acceleration of said device.

17. The device according to claim 15, wherein said embedded positional trigger condition comprises one of:
a specific position of said device;
a relative distance of said device from said specific position;
a velocity of said device generated by said position derivative generation unit;
an acceleration of said device generated by said position derivative generation unit;
a boundary region defined by at least three boundaries;
a proximity of said device to a cartographic feature;
a proximity of said device to another wireless device; and
a device location history.

18. The device according to claim 15, wherein said positional condition executable task comprises one of:
an executable reminder task;
an automatic data download task;
an operating system housekeeping task;
an active task termination function;
an automatic communication function; and
automatic control of normally user-controlled subsystem of said device.

19. A method of triggering a positional condition executable task on a digital processing apparatus based on a positional trigger condition, the method comprising:
determining a position of a device;
generating a position derivative of said device from said determined position;
receiving a positional trigger condition to execute a positional condition executable task stored in a storage memory;
determining if said positional trigger condition is satisfied based on one of said determined position of said device and said generated derivative from said position of said device; and
executing said positional condition executable task based on said positional trigger condition being satisfied.

20. A programmable storage medium tangibly embodying a program of machine-readable instructions executable by a digital processing apparatus to perform operations supporting executing a positional condition program, the operations comprising:
creating an executable program;
creating a position specific executable condition that allows said program to execute on said digital processing apparatus when said position specific executable condition is satisfied;
embedding said position specific executable condition in said program;
transferring said program including said embedded position specific executable condition to a digital processing apparatus; and
executing said program including said embedded position specific executable condition when said position specific executable condition is determined to be satisfied by said digital processing apparatus.
